(19) United States
(12) Patent Application Publication
(10) Pub. No.: US 2015/0363377 A1
(43) Pub. Date: Dec. 17, 2015

(54) INFORMATION PROCESSING DEVICE, DISPLAY METHOD, AND COMPUTER-READABLE, NON-TRANSITORY MEDIUM

(71) Applicant: PFU LIMITED, Kahoku-shi (JP)

(72) Inventors: Go Dojo, Kahoku-shi (JP); Hitoshi Nakano, Kahoku-shi (JP)

(21) Appl. No.: 14/492,904

(22) Filed: Sep. 22, 2014

(30) Foreign Application Priority Data
Jun. 11, 2014 (JP) 2014-120931

(51) Int. Cl. G06F 17/24; G06Q 10/06

(52) U.S. Cl. CPC G06F 17/243; G06Q 10/063

(57) ABSTRACT

An information processing device includes an operation module for accepting input from a user, a display, a storage for storing a business form image representing a business form, and storing a plurality of item input fields each in association with a position at which each item input field is arranged on the business form image, wherein the plurality of item input fields are categorized into a plurality of groups, and a display control module for displaying a display area including at least an area where all the item input fields included in a specific group among the plurality of groups are arranged in the business form image, changing the specific group to another group among the plurality of groups according to the input from the user accepted by the operation module, and displaying a display area corresponding to the another group on the display.

### CROSS-REFERENCE TO RELATED APPLICATIONS

This application is based upon and claims the benefit of priority of prior Japanese Patent Application No. 2014-120931, filed on Jun. 11, 2014, the entire contents of which are incorporated herein by reference.

### TECHNICAL FIELD

Embodiments discussed in the present specification relate to display an image.

### BACKGROUND

Recently, portable information processing devices with limited screen sizes, such as tablet personal computers (PC), are being widely used. Such information processing devices are increasingly used particularly in businesses that deal with business forms. When such information processing devices are used to deal with business forms, typically utilized are business form data where item input fields to be input by a worker are arranged at item entry positions of an image that represents a business form. Using such business form data, the worker can easily understand where to input each item to be entered, which facilitates smooth operation of the business.

There has been known a content generation and distribution system which generates contents, in which texts, images, and the like are arranged in a particular layout, and causes mobile terminals to display the contents (see Japanese Laid-open Patent Publication No. 2010-288243).

In addition, there has been known an electronic document system in which: procedure processing that is dealt in the same workflow is divided into a plurality of forms; the plurality of divided forms are categorized as a group; then, information of the forms is managed by the unit of group (see Japanese Laid-open Patent Publication No. 2000-330887).

There has also been known a multiwindow system in which a transition destination dialogue box is retrieved on the basis of a screen transition table so that the screen transition is automatically performed between a plurality of dialogue boxes and the retrieved dialogue box is displayed (see Japanese Laid-open Patent Publication No. 2000-105654).

### Patent Literatures

### SUMMARY

In the above examples, since the item input fields are arranged at fixed positions on the image that represents a business form, unlike automatically relocatable documents such as HyperText Markup Language (HTML), the image that represents the business form and the item input fields is hard to be relocated in accordance with the screen size of the information processing device. Thus, in the above example, a whole large-sized image of the business form data is displayed on the small-sized screen of the information processing device. In such a case, the image that represents the business form and the item input fields are displayed small, which makes each piece of information on the image difficult to be viewed and each item input field difficult to be selected. As such, a worker needs to zoom in around desired information to be viewed or desired item input field to be selected and further scroll the screen so that the information or item input field is appropriately displayed.

Accordingly, it is an object of the present invention to provide an information processing device, a display method that can improve user utility when utilizing a business form with the information processing device, and a computer-readable, non-transitory medium storing a computer program for causing a computer to implement such a display method.

According to an aspect of the device, there is provided an information processing device. The information processing device includes an operation module for accepting input from a user, a display, a storage for storing a business form image representing a business form, and storing a plurality of item input fields each in association with a position at which each item input field is arranged on the business form image, wherein the plurality of item input fields are categorized into a plurality of groups, and a display control module for displaying a display area including at least an area where all the item input fields included in a specific group among the plurality of groups are arranged in the business form image, changing the specific group to another group among the plurality of groups according to the input from the user accepted by the operation module, and displaying a display area corresponding to the another group on the display.

According to an aspect of the method, there is provided a display method for an information processing device which includes an operation module accepting input from a user, a display, and a storage. The display method includes storing a business form image representing a business form in the storage, and storing a plurality of item input fields each in association with a position at which each item input field is arranged on the business form image in the storage, wherein the plurality of item input fields are categorized into a plurality of groups, displaying a display area including at least an area where all the item input fields included in a specific group among the plurality of groups are arranged in the business form image on the display, and changing, using a computer, the specific group to another group among the plurality of groups according to the input from the user accepted by the operation module, and displaying a display area corresponding to the another group on the display.

According to an aspect of the computer-readable, non-transitory medium storing a computer program, the computer program causes a computer which comprises an operation module accepting input from a user, a display, and a storage, to execute a process, including storing a business form image representing a business form in the storage, and storing a plurality of item input fields each in association with a position at which each item input field is arranged on the business form image in the storage, wherein the plurality of item input fields are categorized into a plurality of groups, displaying a display area including at least an area where all the item input fields included in a specific group among the plurality of groups are arranged in the business form image on the display, and changing the specific group to another group among the plurality of groups according to the input from the user accepted by the operation module, and displaying a display area corresponding to the another group on the display.

The object and advantages of the invention will be realized and attained by means of the elements and combinations particularly pointed out in the claims. It is to be understood that both the foregoing general description and the following detailed description are exemplary and explanatory, and are not restrictive of the invention, as claimed.

### BRIEF DESCRIPTION OF THE DRAWINGS

FIG. 1 is a diagram depicting an information processing system 1 according to an embodiment.

FIG. 2 is a schematic view depicting an example of a business form image.

FIG. 3A is a schematic view depicting an example of input information definition data.

FIG. 3B is a schematic view depicting an example of group information definition data.

FIG. 4 is a diagram depicting an example of a schematic structure of an information processing device 100.

FIG. 5 is a diagram depicting an example of a schematic structure of a CPU 110.

FIG. 6 is a flowchart depicting an example of the operation of input data entry processing.

FIG. 7 is a schematic view depicting an example of a business form layout image.

FIG. 8A is a schematic view depicting an example of a group image.

FIG. 8B is a schematic view depicting an example of a group image.

FIG. 9 is a flowchart depicting an example of the operation of business form layout image display processing.

FIG. 10 is a flowchart depicting an example of the operation of group image display processing.

FIG. 11 is a schematic view depicting an example of group display information definition data.

FIG. 12 is a flowchart depicting an example of the operation of group image change processing.

FIG. 13A is a schematic view for illustrating a branch source group and a branch destination group.

FIG. 13B is a schematic view for illustrating a branch source group and a branch destination group.

FIG. 14A is a schematic view for illustrating a branch source group and a branch destination group.

FIG. 14B is a schematic view for illustrating a branch source group and a branch destination group.

FIG. 15 is a schematic view for illustrating an input determination.

### DESCRIPTION OF EMBODIMENTS

Hereinafter, an information processing device, display method, and computer program according to an embodiment, will be described with reference to the drawings. However, it should be noted that the technical scope of the invention is not limited to these embodiments, and extends to the inventions described in the claims and their equivalents.

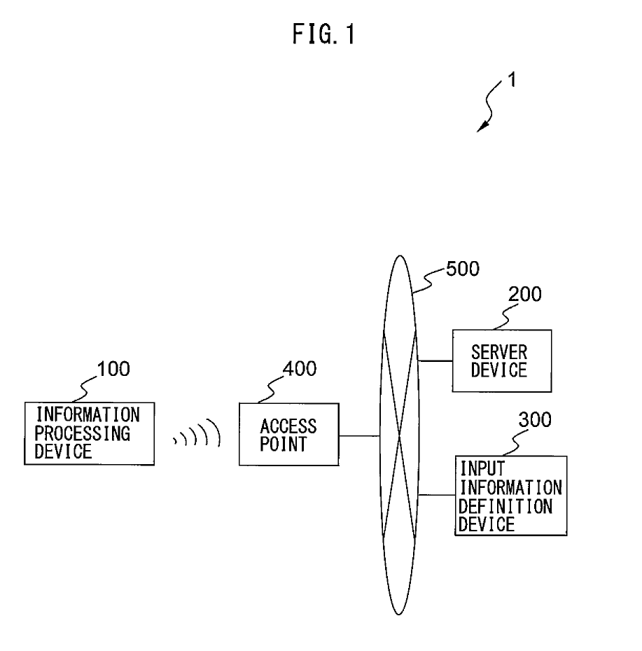

FIG. 1 is a diagram depicting an information processing system 1 according to an embodiment.

The information processing system 1 includes an information processing device 100, a server device 200, and an input information definition device 300.

The information processing device 100 includes a wireless local area network (LAN) communication function and is connected to a wireless LAN access point 400. The access point 400 wirelessly communicates with the information processing device 100 in accordance with the wireless LAN communication method within a service area. Further, the access point 400 is connected to a wired network 500. The wired network 500 is connected to the server device 200, the input information definition device 300, and the like via a wired LAN, such as Ethernet (registered trademark). The information processing device 100 can communicate with the server device 200, and the server device 200 can communicate with the input information definition device 300.

Note that, instead of a wireless LAN communication function, the information processing device 100 may have another wireless communication function such as a portable telephone communication function or a wired communication function such as a wired LAN communication function, to connect with the wired network 500 in accordance with the communication method and communicate with the server device 200.

The server device 200 is a server that manages business form data used by the information processing device 100. The business form is a document including items that a worker can input into. The server device 200 stores image data that represents a business form registered by an administrator (hereinafter, referred to as the business form image).

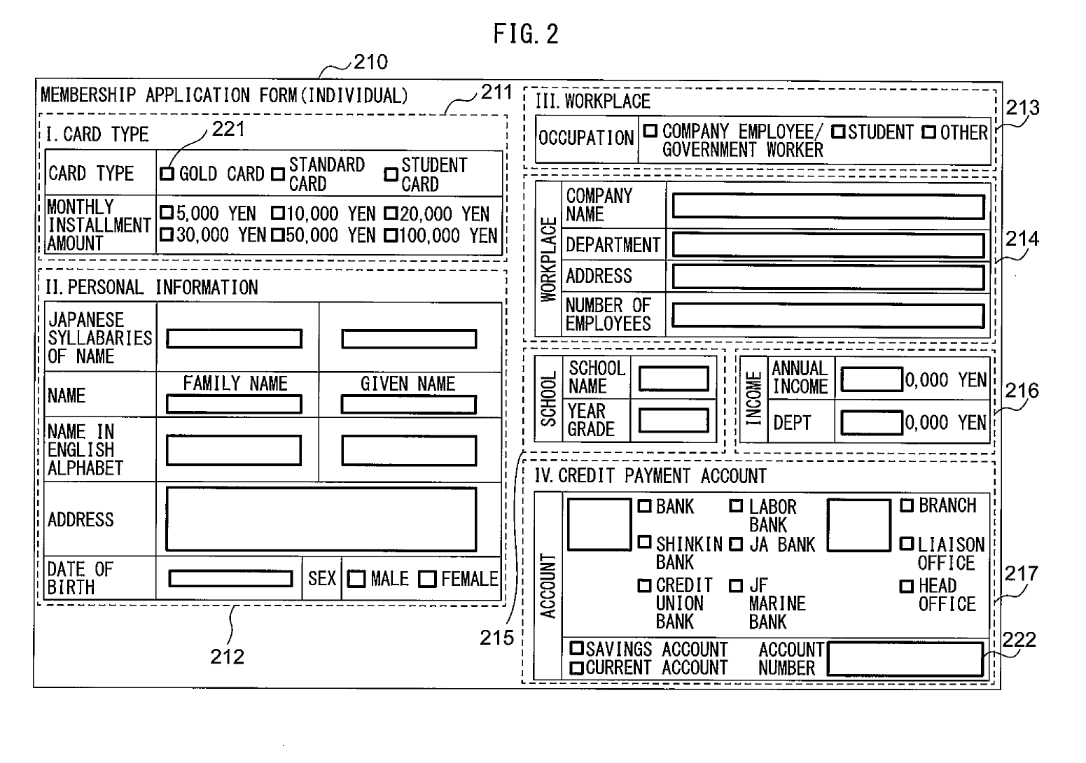

FIG. 2 is a schematic view depicting an example of a business form image 210.

Each of a plurality of rectangles indicated by bold lines in FIG. 2 indicates an item entry frame to be entered by a worker. As depicted in FIG. 2, a plurality of item entry frames are arranged in the business form image 210. The item entry frames include check frames 221 for selecting specific items by checking, and text frames 222 that are entered characters, numbers, and the like. The item entry frames in the business form image 210 are categorized into a plurality of groups 211 to 217 by an operator of the input information definition device 300.

Further, according to a request from the input information definition device 300, the server device 200 transmits the business form image to the input information definition device 300. Then, the server device 200 stores the input information definition data, group information definition data, and group display information definition data of the business form image registered by the input information definition device 300 in association with the business form image. The input information definition data is data that defines an input content, and a position, size, type and the like for accepting an input, for each item to be entered in each item entry frame arranged in the business form image 210. The group information definition data is data that defines the name, position, size, and the like of each group that is categorized by the operator of the input information definition device 300. The group display information definition data is data that defines a display order and the like of the groups. The details of the group display information definition data will be described later herein.

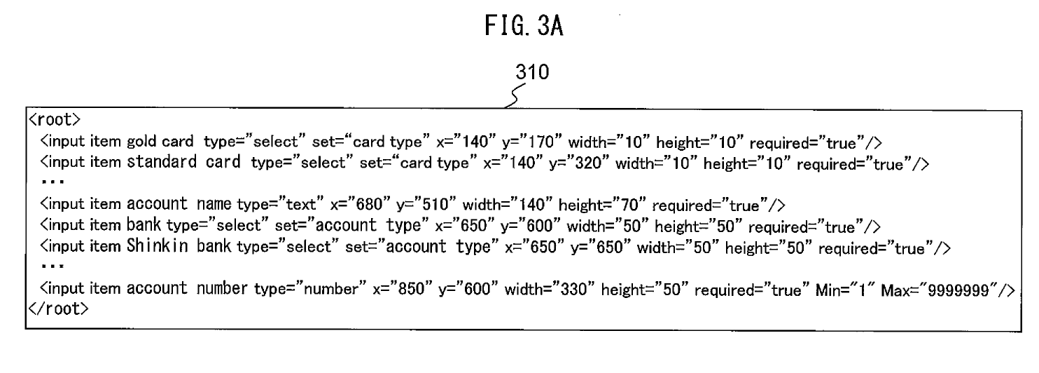

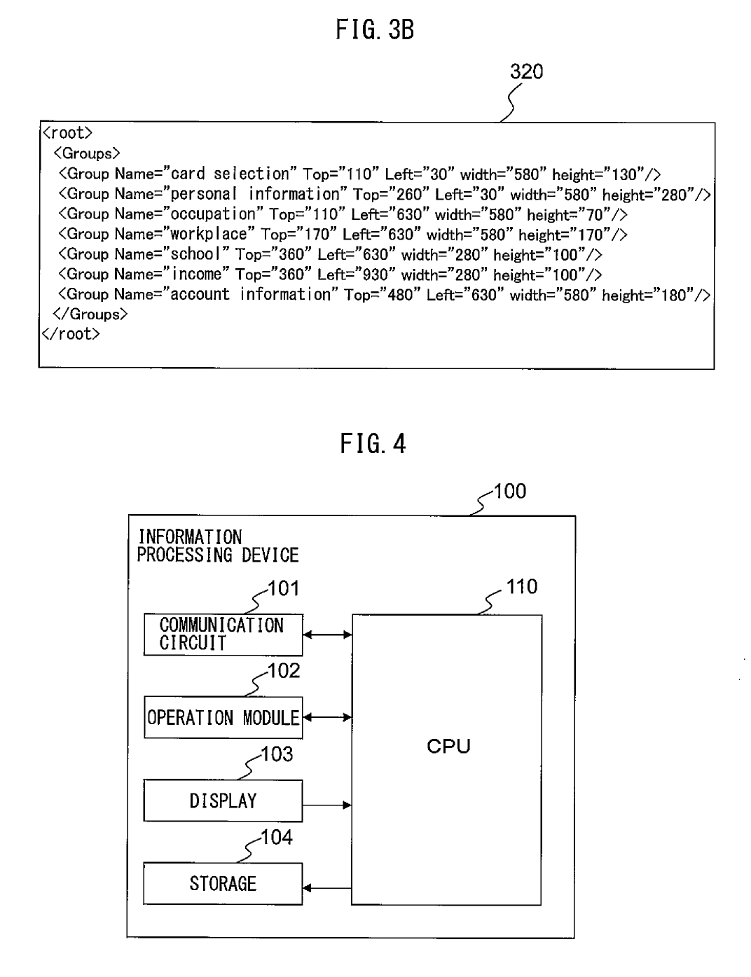

FIG. 3A is a schematic view depicting an example of the input information definition data.

As depicted in FIG. 3A, the input information definition data 310 associates and stores, for a plurality of items, the names of the items, input types, positions where item input fields for accepting information to be input by a worker are arranged, the sizes of the item input fields, required input information, and the like. The input type (type) is a type of input for corresponding item, specified by a text input (text), a numerical input (number), a select input (select), or the like. The select input is a type in which a valid item is selected from a plurality of items. When the input type is the select input, in association with the item, information that indicates a set of a plurality of items as selection objects (set) is further stored. The position where the item input field is arranged is specified by a horizontal position (x), a vertical position (y) or the like on the image in which the item input field is arranged. The size of the item input field is specified by a width (width), a height (height) or the like.

The required input information (required) is specified by whether input of the item is required (true) or not (false). When the input of the item is required, in association with the item, a range within which data to be input is supposed to be included (Min, Max), the character type of the data to be input, and the like may be further stored.

FIG. 3B is a schematic view depicting an example of group information definition data.

As depicted in FIG. 3B, for a plurality of groups into which the item input fields are categorized, the group information definition data 320 stores the names, positions, sizes and the like of the groups in association with each other. Each group is specified by a rectangular area in the business form image, and the item input fields arranged in the rectangular area are the item input fields included in the group. The position of each group is specified by a vertical position (Top), horizontal position (Left), or the like of the upper left corner of the rectangle that forms each group. The size of each group is specified by a width (width), a height (height) or the like.

Further, the server device 200, in response to a request from the information processing device 100, transmits the business form image, the input information definition data, the latest input data that has been input to the item input fields, the group information definition data, and the group display information definition data to the information processing device 100. Hereinafter, the business form image, input information definition data, input data, group information definition data, and group display information definition data may be collectively referred to as the business form data. Note that the initial value of input data, i.e., the input data before being input by the information processing device 100 is blank.

When receiving the business form data that includes input data newly input to the item input fields from the information processing device 100, the server device 200 stores the received business form data. Thereafter, when requested acquisition of the business form data from the information processing device 100, the server device 200 transmits the business form data that includes the latest input data to the information processing device 100. Further, the server device 200 extracts the input data from the business form data and manages the input data. In response to a request from a device that utilizes the input data, the extracted input data is transmitted to the device where the input data is utilized.

The input information definition device 300 is a device for the operator to create input information definition data, group information definition data, group display information definition data, and the like. In accordance with the operation by the operator, the input information definition device 300 requests the server device 200 to acquire the business form image and displays the acquired business form image. In accordance with the operation by the operator, the input information definition device 300 generates input information definition data, group information definition data, and group display information definition data. The input information definition device 300 transmits and registers the generated input information definition data, group information definition data, and group display information definition data with the business form image to the server device 200. As such, the operator can easily add, delete, or change the item input fields by changing each piece of information definition data.

FIG. 4 is a diagram depicting an example of a schematic structure of the information processing device 100.

The information processing device 100 is an information processing device, such as a tablet PC, a multi-function portable telephone (so-called smartphone), a portable digital assistant, or a laptop PC, and used by a worker as a user. The information processing device 100 has a communication circuit 101, an operation device 102, a display device 103, a storage device 104, and a CPU (Central Processing Unit) 110. The following will describe each component of the information processing device 100 in detail.

The communication circuit 101 includes a communication interface circuit including an antenna that has a sensitive band mainly at 2.4 GHz band, 5 GHz band, and the like. The communication circuit 101 wirelessly communicates with the access point 400 based on the wireless communication method of IEEE (The Institute of Electrical and Electronics Engineers, Inc.) 802.11 standard. Then, the communication circuit 101 supplies data received from the server device 200 via the access point 400 to the CPU 110. Further, the communication circuit 101 transmits data supplied from the CPU 110 to the server device 200 via the access point 400. Note that the communication circuit 101 may be of any kind as long as it is capable of communicating with the server device 200. For example, the communication circuit 101 may communicate with the server device 200 via a base station device, not depicted, according to a portable telephone communication method, or communicate with the server device 200 according to a wired LAN communication method.

The operation device 102 is an example of the operation module, which includes: a touch panel style input device; input equipment, such as a keyboard and a mouse; and an interface circuit that acquires a signal from the input equipment. The operation device 102 accepts a user input and outputs a signal according to the user input to the CPU 110.

The display device 103 is an example of the display, which includes: a display that is configured by liquid crystal, organic electro-luminescence (EL), or the like; and an interface circuit that outputs image data or various information to the display. The display device 103 is connected to the CPU 110 and displays the image data that is output from the CPU 110 on the display. Note that the operation device 102 and the display device 103 may be integrally configured using a touch panel display.

The storage device 104 is an example of the storage. The storage device 104 includes: a memory device, such as a RAM (Random Access Memory) and a ROM (Read Only Memory); a fixed disc device, such as a hard disk; or a portable storage, such as a flexible disc and an optical disc. Further, the storage device 104 stores a computer program, a database, a table, and the like that are used for various processing of the information processing device 100. The computer program may be installed on the storage device 104 from a computer-readable, non-transitory medium such as a compact disk read only memory (CD-ROM), a digital versatile disk read only memory (DVD-ROM), or the like by using a well-known setup program or the like.

Further, the storage device 104 stores the business form data acquired from the server device 200. The storage device 104 further stores the resolution in the longitudinal direction and the resolution in the lateral direction of the display screen of the display device 103. Note that, in the present embodiment, the resolution refers to the number of pixels displayed on the display screen.

The CPU 110 is connected to and controls the communication circuit 101, the operation device 102, the display device 103, and the storage device 104. The CPU 110 controls: transmission and reception of data with the server device 200 via the communication circuit 101; input of the operation device 102; display of the display device 103; and the storage device 104.

Further, in accordance with the operation by the worker using the operation device 102, the CPU 110 requests acquisition of the business form data to the server device 200 and stores the acquired business form data to the storage device 104. Further, in accordance with the operation by the operator using the operation device 102, the CPU 110 transmits, to the server device 200, the business form data including input data that is newly input.

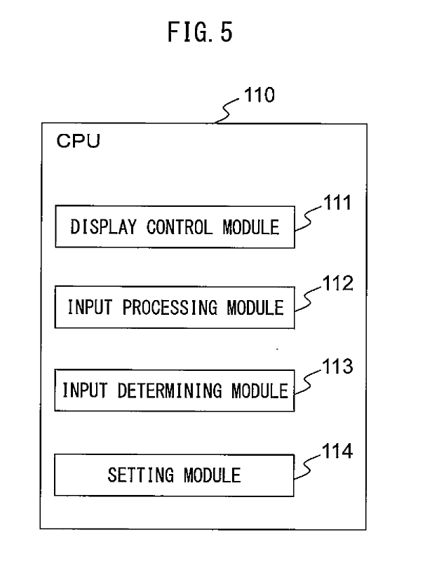

FIG. 5 is a diagram depicting an example of the schematic structure of the CPU 110. As depicted in FIG. 5, the CPU 110 has a display control module 111, an input processing module 112, an input determining module 113, and a setting module 114. Each module is a functional module implemented by software that operates on a processor. Note that each of the modules may be separately configured by an independent integrated circuit, a microprocessor, firmware, or the like.

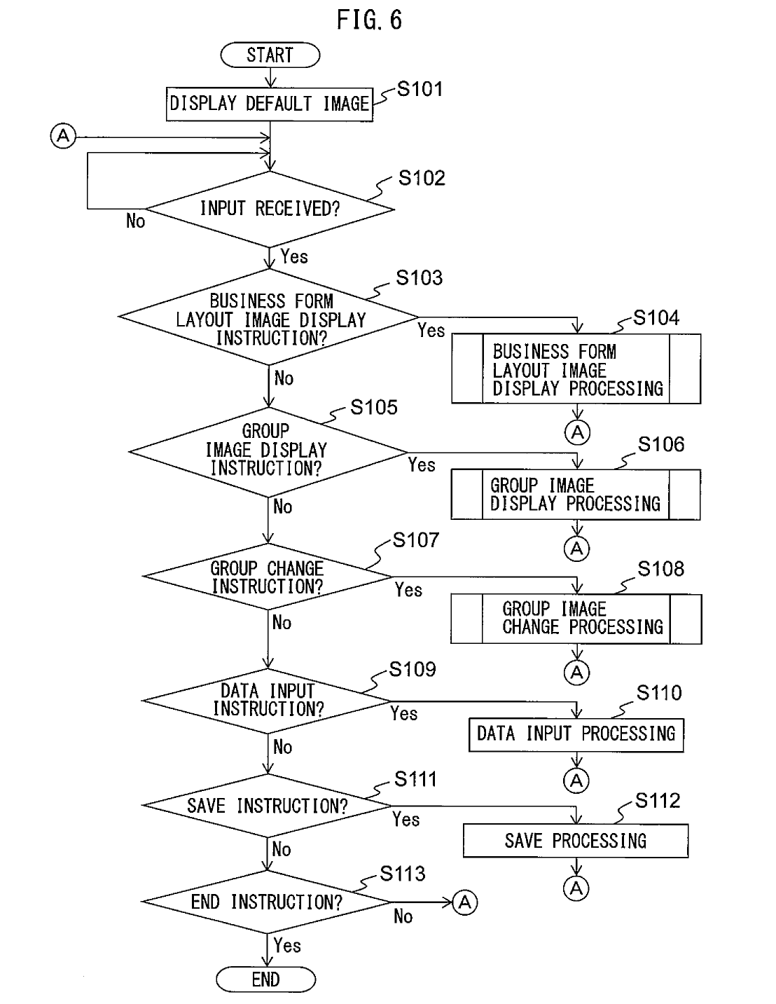

FIG. 6 is a flowchart depicting an example of the operation of input data entry processing by the information processing device 100.

The following will illustrate an example of the operation of the whole processing of the information processing device 100 with reference to the flowchart depicted in FIG. 6. The operation flow as will be described below is performed primarily by the CPU 110 jointly with each component of the information processing device 100 according to a program prestored in the storage device 104. Note that the flowchart depicted in FIG. 6 is carried out when the operator instructs editing of the business form data using the operation device 102.

Initially, the display control module 111 displays the default image that represents information relating to the business form data on the display device 103 (step S101). The default image is either a business form layout image or a group image, and the default image is preset to either of the images.

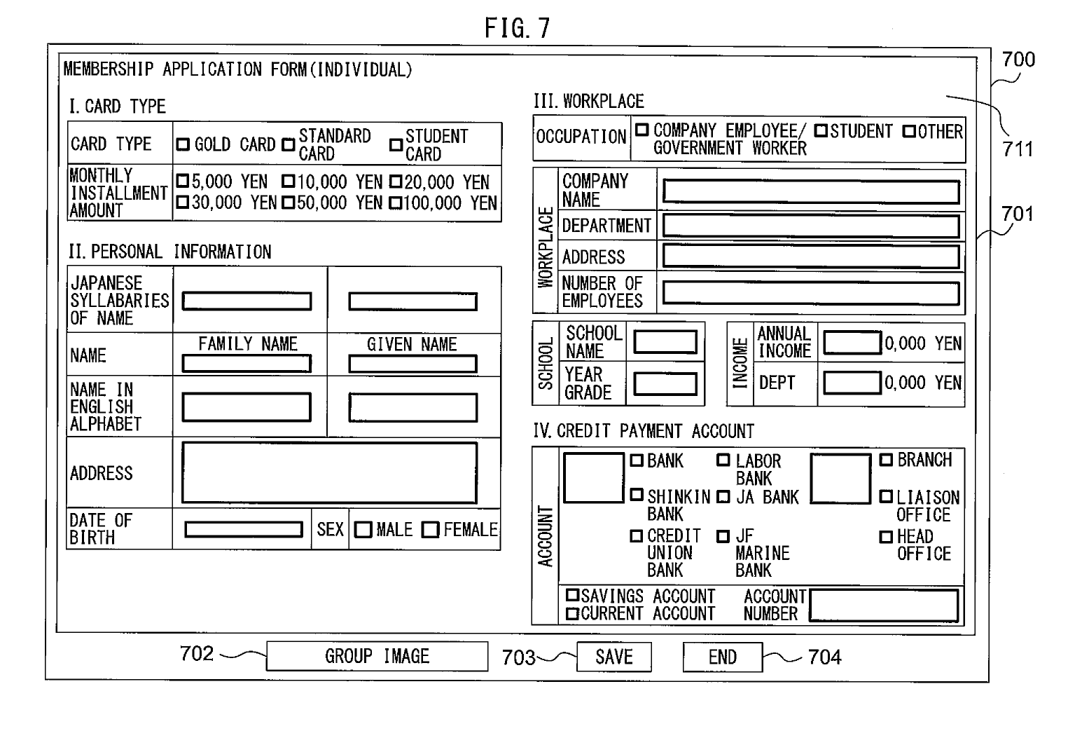

FIG. 7 is a schematic view depicting an example of the business form layout image.

FIG. 7 depicts a business form layout image window 700 on which the business form layout image is displayed. The business form layout image window 700 includes: a business form layout image form 701; a Group Image display button 702; a Save button 703; and an End button 704.

The business form layout image form 701 displays the business form layout image 711. The business form layout image 711 is an image where the item input fields indicated by bold lines are arranged at positions of the item entry frames on the business form image 210 depicted in FIG. 2 on the basis of the input information definition data 310 depicted in FIG. 3. Each of the item input fields is an object that is enabled inputting of information when selected (tapped) by the worker. The latest information input by the worker is displayed in each item input field.

The Group Image display button 702 is a button for switching the business form layout image window 700 to a group image window as will be described later. The Save button 703 is a button for storing information that is currently input in the item input field. The End button 704 is a button for closing the business form layout image window 700.

The business form layout image 711 depicted in FIG. 7 includes a plurality pieces of information and the item input fields. When the business form layout image window 700 is displayed on the display screen of the display device 103, the information and item input fields are displayed small. Therefore, the worker cannot easily view information or select each item input field on the business form layout image 711.

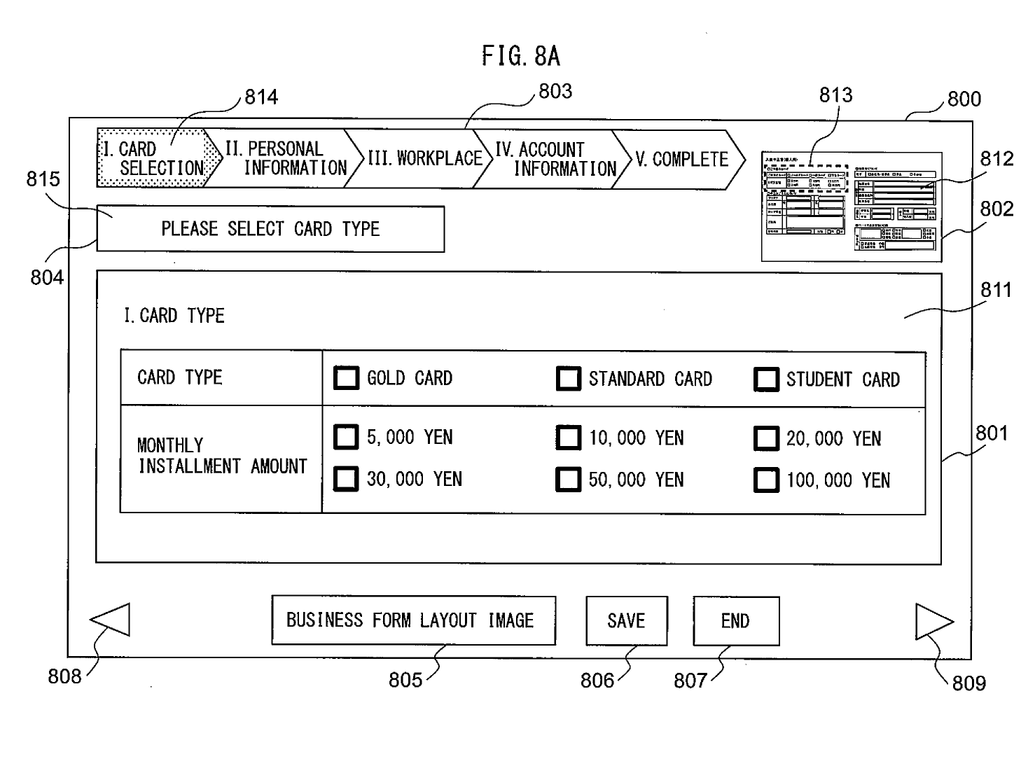

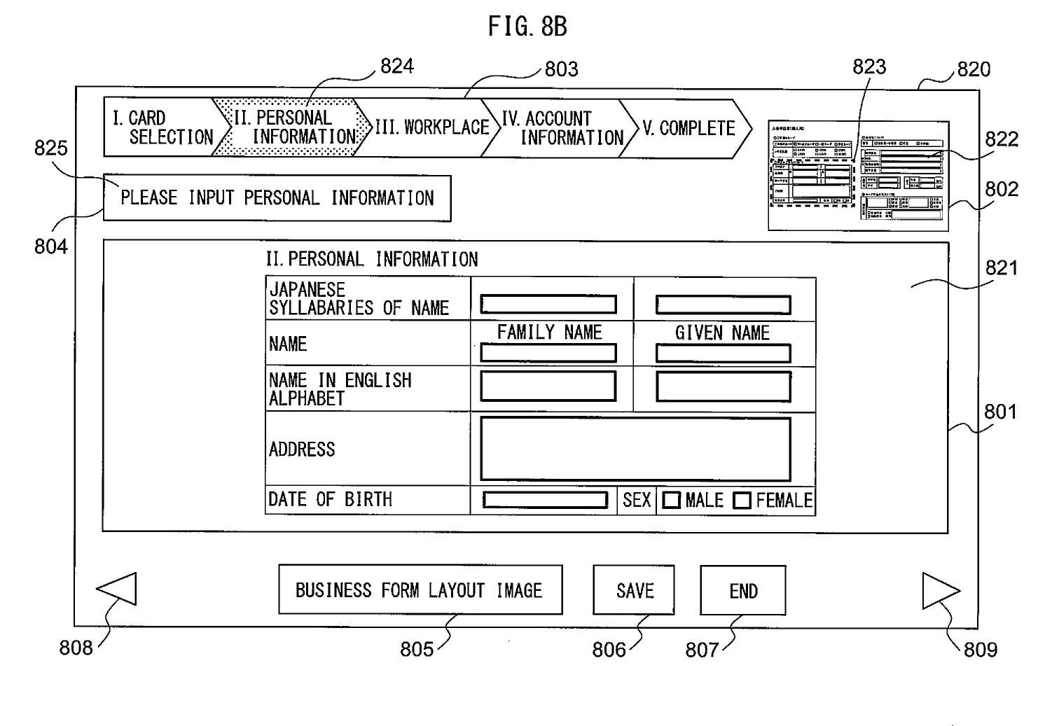

FIGS. 8A and 8B are schematic views each depicting an example of the group image.

FIG. 8A depicts a group image window 800 on which a group image is displayed. The group image window 800 includes a group image form 801, a guide image form 802, a list form 803, and an instruction form 804. Further, the group image window 800 includes a Business form Layout Image display button 805, a Save button 806, an End button 807, a display previous button 808, and a display next button 809.

The group image form 801 displays a group image 811. The group image 811 is an image corresponding to the display area that includes at least the area, in the business form image, in which all item input fields included in a specific group among a plurality of groups are arranged. The group image 811 depicted in FIG. 8A is an image corresponding to the “card selection” group. The item input fields in the group image 811 are objects that are enabled inputting of information when selected by the worker in the same way as the item input fields in the business form layout image 711. The item input fields display the latest information input by the worker.

The guide image form 802 displays a guide image 812. The guide image 812 is an image that represents the whole business form image as well as distinguishably represents the display area that is displayed as the group image in the whole business form image. The guide image 812 depicted in FIG. 8A is an image that distinguishably represents the display area 813 corresponding to the group image 811 in the whole business form image. By viewing the guide image, the user can understand which area in the whole business form image is currently displayed.

The list form 803 represents all the groups in the display order, and the group corresponding to the group image that is currently displayed among all the groups is distinguishably indicated. The list form 803 depicted in FIG. 8A distinguishably displays the “card selection” group 814 corresponding to the group image 811. By viewing the list form, the user can understand to which group the currently displayed group image corresponds.

The instruction form 804 represents an instruction to the worker. The instruction form 804 depicted in FIG. 8A displays the instruction 815 that instructs to select a card type.

The Business form Layout Image display button 805 is a button for switching the group image window 800 to the business form layout image window 700. The Save button 806 is a button for storing information that is currently input in the item input fields. The End button 807 is a button for closing the group image window 800. The display previous button 808 is a button for switching the group image 811 to a previous group image. The display next button 809 is a button for switching the group image 811 to a next group image.

The group image form 801 displays only the item input fields included in a specific group and the area corresponding to the item input fields. Each piece of information and item input field on the group image 811 are displayed larger than when displayed in the business form layout image form 701. Therefore, the worker can easily view each piece of information and select each item input field on the group image 811.

FIG. 8B depicts a group image window 820 displayed when the display next button 809 is pressed in the group image window 800 depicted in FIG. 8A. The group image 821 displayed on the group image window 820 is an image corresponding to the “personal information” group. The guide image 822 is an image that distinguishably represents the display area 823 corresponding to the group image 821 in the whole business form image. The list form 803 distinguishably displays the “personal information” group 824 corresponding to the group image 821. The instruction form 804 displays an instruction 825 that instructs inputting of personal information.

As such, when the worker presses either the display previous button 808 or the display next button 809, the item input fields displayed on the display screen can be easily switched to the item input fields of another group.

The display control module 111 generates a business form layout image or a group image as a default image, based on the input information definition data and the like, and displays the image on the display device 103. The details of the method of generating the business form layout image and group image will be described later herein.

Next, the display control module 111 stands by until the operation device 102 accepts an input from the worker (step S102).

Next, when the operation device 102 accepts an input from the worker, the display control module 111 determines whether or not the accepted input is a display instruction of the business form layout image (step S103). For example, when the Business form Layout Image display button 805 depicted in FIGS. 8A and 8B is pressed (tapped), the display control module 111 determines that the accepted input is a display instruction of the business form layout image.

When the accepted input is a display instruction of the business form layout image, the display control module 111 carries out the business form layout image display processing (step S104), and returns the processing to step S102. In the business form layout image display processing, the display control module 111 displays the business form layout image on the display device 103. The details of the business form layout image display processing will be described later herein.

Whereas, when the accepted input is not a display instruction of the business form layout image, the display control module 111 determines whether or not the accepted input is a display instruction of the group image (step S105). For example, when the Group Image display button 702 depicted in FIG. 7 is pressed, the display control module 111 determines that the accepted input is a display instruction of the group image.

When the accepted input is a display instruction of the group image, the display control module 111 carries out the group image display processing (step S106), and returns the processing to step S102. In the group image display processing, the display control module 111 displays the group image on the display device 103. The details of the group image display processing will be described later herein.

Whereas, when the accepted input is not a display instruction of the group image, the display control module 111 determines whether or not the accepted input is a change instruction of the group image (step S107). For example, when the display previous button 808 or the display next button 809 depicted in FIGS. 8A and 8B is pressed down, the display control module 111 determines that the accepted input is a change instruction of the group image.

When the accepted input is a change instruction of the group image, the display control module 111 carries out the group image change processing (step S108), and returns the processing to step S102. In the group image change processing, the display control module 111 changes the group displayed on the display device 103 to another group, and displays the group image corresponding to the another group on the display device 103. The details of the group image change processing will be described later herein.

Whereas, when the accepted input is not a change instruction of the group image, the display control module 111 determines whether or not the accepted input is a data input instruction (step S109). For example, when an item input field in the business form layout image or the group image is specified by pressing (tapping) thereon, the display control module 111 determines that the accepted input is a data input instruction.

When the accepted input is a data input instruction, the input processing module 112 accepts information such as specific characters, numbers, and the like input by the worker using the operation device 102. The input processing module 112 temporarily stores the accepted information in association with the specified item input field to the storage device 104, as well as, displays the accepted information in the item input field specified on the currently displayed image (step S110), and returns the processing to step S102.

Whereas, when the accepted input is not a data input instruction, the display control module 111 determines whether or not the accepted input is a save instruction (step S111). For example, when the Save button is pressed, the display control module 111 determines the accepted input is a save instruction.

When the accepted input is a save instruction, the input processing module 112 stores each set of input information and the item input field that have been temporarily stored at step S110 as input data to the storage device 104 (step S112) and returns the processing to step S102.

Whereas, when the accepted input is not a save instruction, the display control module 111 determines whether or not the accepted input is a terminate instruction (step S113). For example, when the End button is pressed, the display control module 111 determines the accepted input is a terminate instruction.

When the accepted input is not a terminate instruction, the display control module 111 returns the processing to step S102. When the accepted input is a terminate instruction, the display control module 111 terminates the series of steps.

As such, in accordance with the input from a user using the operation device 102, the display control module 111 switches the business form layout image and the group image and displays on the display device 103. Since the worker can switch the display image so as to display the business form layout image when checking the whole business form and display a group image when inputting each item, the worker can perform tasks while viewing an appropriate image.

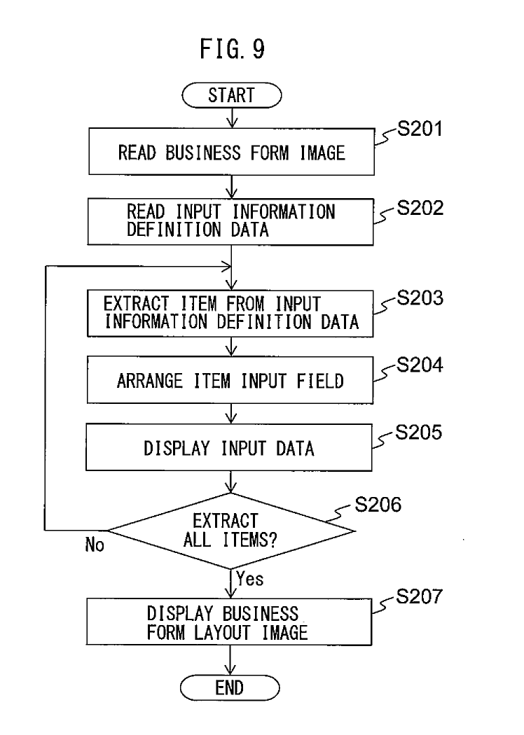

FIG. 9 is a flowchart depicting an example of the operation of the business form layout image display processing.

The operation flow depicted in FIG. 9 is carried out at step S104 of the flowchart depicted in FIG. 6.

The display control module 111 initially reads out a business form image included in the business form data from the storage device 104 (step S201).

Next, the display control module 111 reads out the input information definition data included in the business form data from the storage device 104 (step S202).

Next, the display control module 111 extracts unprocessed items from the read out input information definition data (step S203).

Next, the display control module 111 arranges the item input fields of the extracted items on the business form image (step S204). The display control module 111 identifies the names, input types, the sizes of the item input fields, and arrangement positions of the extracted items from the input information definition data, then, arranges the item input fields of the sizes for inputting the input contents in the input types at the arrangement positions on the business form image.

Next, the display control module 111 determines whether or not the input data corresponding to the item input fields of the extracted items is stored in the storage device 104, and, when stored, displays the corresponding input data in the item input fields (step S205).

Next, the display control module 111 determines whether or not processing has completed for all the items included in the input information definition data (step S206).

When processing has not completed for all the items included in the input information definition data, the display control module 111 returns the processing to step S203 and repeats the processing of steps S203 to S205.

Whereas, when processing has completed for all the items included in the input information definition data, the display control module 111 generates a business form layout image window, displays the business form layout image window on the display device 103 (step S207), then, terminates the series of steps. The display control module 111 generates a business form layout image window in which a business form layout image where the item input fields are arranged on a business form image is arranged in a business form layout image form.

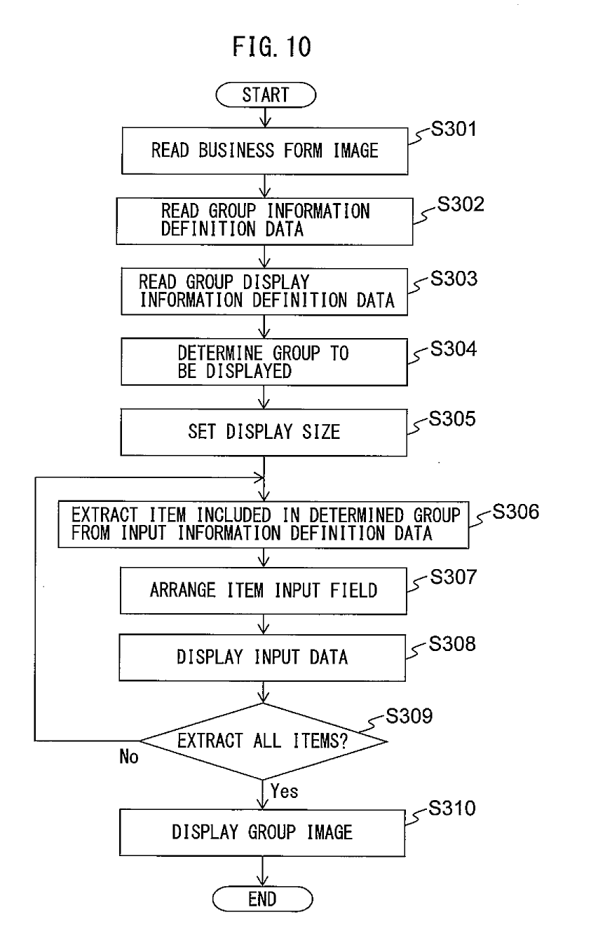

FIG. 10 is a flowchart depicting an example of the operation of the group image display processing.

The operation flow depicted in FIG. 10 is carried out at step S106 of the flowchart depicted in FIG. 6. Further, the operation flow depicted in FIG. 10 is also carried out in the group image change processing as will be described later.

The display control module 111 initially reads out a business form image included in the business form data from the storage device 104 (step S301).

Next, the display control module 111 reads out group information definition data included in the business form data from the storage device 104 (step S302).

Next, the display control module 111 reads out group display information definition data included in the business form data from the storage device 104 (step S303).

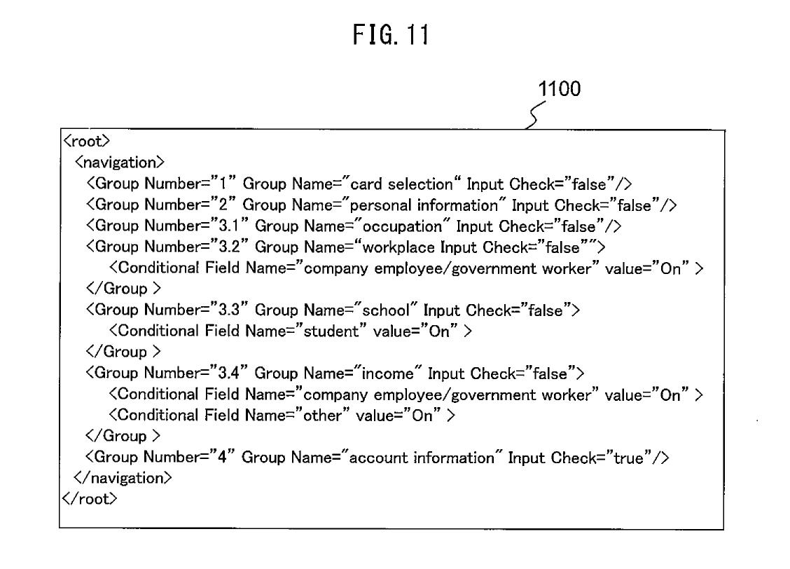

FIG. 11 is a schematic view depicting an example of the group display information definition data.

As depicted in FIG. 11, for a plurality of groups included in the group information definition data depicted in FIG. 3B, in the group display information definition data 1100, the display orders, names, input check flags and the like of the groups are stored in association with each other.

The display order (Group Number) indicates the order in which groups are displayed, and the group images corresponding to the groups are displayed in an ascending order of the display order. Among the groups that include decimal part in the display order, the plurality of groups that have the same integer part represent a set of branch groups, to which branch processing where a group to be displayed next changes according to the input data is performed. The group that has the decimal part of the least value (1) among the set of branch groups is the branch source group that is displayed first among the set of branch groups. The branch destination group other than the branch source group is associated with a data candidate (value) that is input to a predetermined item input field (Conditional Field Name) included in the branch source group and stored.

In an example depicted in FIG. 11, the “occupation” group, “workplace” group, “school” group and “income” group that have the integer part of the display order ‘3’ are a set of branch groups. In this set of branch groups, the “occupation” group with the display order 3.1 becomes the branch source group, and the “workplace” group with the display order 3.2, the “school” group with the display order 3.3 and the “income” group with the display order 3.4 are branch destination groups. The “workplace” group is associated with a data candidate “On” that is input in the item input field “company employee/government worker” included in the “occupation” group. The “school” group is associated with a data candidate “On” that is input in the item input field “student”. The “income” group is associated with a data candidate “On” that is input in the item input field “company employee/government worker” and a data candidate “On” that is input in the item input field “other”.

The group name (Group Name) corresponds to the group name in the group information definition data depicted in FIG. 3B. The input check flag (Input Check) is a flag to define whether or not to check if an input to a specific item input field included in the group satisfies a predetermined condition, to which either valid (true) or invalid (false) is set.

Next, the display control module 111 determines a group to be displayed according to the display order indicated by the read group display information definition data (step S304). When the group image display processing is carried out at step S106 of the flowchart depicted in FIG. 6, the display control module 111 determines a group with the display order of the least value (1) as the group to be displayed. Whereas, when the group image display processing is carried out in the group image change processing as will be described later, the display control module 111 determines the group determined in the group image change processing as the group to be displayed.

Next, the setting module 114 sets the display size of the group image, based on the length of at least one direction among the horizontal and vertical directions of the group image relating to the determined group and the length of the same direction of the group image window (step S305).

The setting module 114 acquires the lengths in the horizontal and vertical directions of the group image window that is currently displayed on the display device 103. Note that, when the group image window is displayed in full screen on the display screen of the display device 103, the setting module 114 may acquire the lengths in the horizontal and vertical directions of the group image window from the resolution in the lateral direction and the resolution in the longitudinal direction of the display screen that are stored in the storage device 104. The ratio of the size of the group image form with reference to the size of the group image window is predefined. The setting module 114 calculates the lengths in the horizontal and vertical directions of the group image form based on the lengths in the horizontal and vertical directions of the group image window and the predefined ratio. Further, the setting module 114 reads out the lengths in the horizontal and vertical directions of the group image from the group information definition data.

The setting module 114 sets the scale factor of the display size of the group image so that the whole group image can be fit in the group image form, based on the lengths in the horizontal and vertical directions of the group image and the lengths in the horizontal and vertical directions of the group image form. As such, the display control module 111 can display the group image as large as possible while displaying the whole group image. Further, the setting module 114 may set the scale factor of the size of the group image for one direction among the horizontal and vertical directions of the group image form so that the group image can be fit in the group image form. When the group image does not fit in the group image form with regard to the other direction of the group image form, the worker can view all the item input fields in the group image by scrolling the group image only in the other direction.

The display control module 111 changes the display size of the group image according to the scale factor set by the setting module 114.

Next, the display control module 111 extracts items included in the group determined at step S304 from the input information definition data (step S306). The display control module 111 identifies the rectangular area in the business form image corresponding to the determined group from the group information definition data, and extracts items of which item input fields are arranged in the identified rectangular area as the items included in the group from the input information definition data.

Next, the display control module 111 arranges the item input fields of the extracted items on the business form image (step S307). The display control module 111 identifies, for the extracted items, the names, input types, the sizes of the item input fields, and arrangement positions from the input information definition data, and arranges the item input fields of the sizes for inputting the input contents in the input types at the arrangement positions on the business form image.

Next, the display control module 111 determines whether or not the input data corresponding to the item input fields of the extracted items are stored in the storage device 104, and, when stored, displays the corresponding input data on the item input fields (step S308).

Next, the display control module 111 determines whether or not all the items included in the determined group are extracted (step S309).

When all the items included in the group have not been extracted, the display control module 111 returns the processing to step S306 and repeats the processing of steps S306 to S308.

Whereas, when all the items included in the group have been extracted, the display control module 111 generates a group image window corresponding to the group, displays the group image window on the display device 103 (step S310), and terminates the series of steps. The display control module 111 generates a group image window where a group image, including the area where the extracted item input fields are arranged on the business form image, is arranged in a group image form. Further, the display control module 111 arranges a guide image that distinguishably represents the display area corresponding to the group image among the whole business form image in a guide image form. Further, the display control module 111 distinguishably displays the group in a list form, and displays an instruction to the worker in an instruction form.

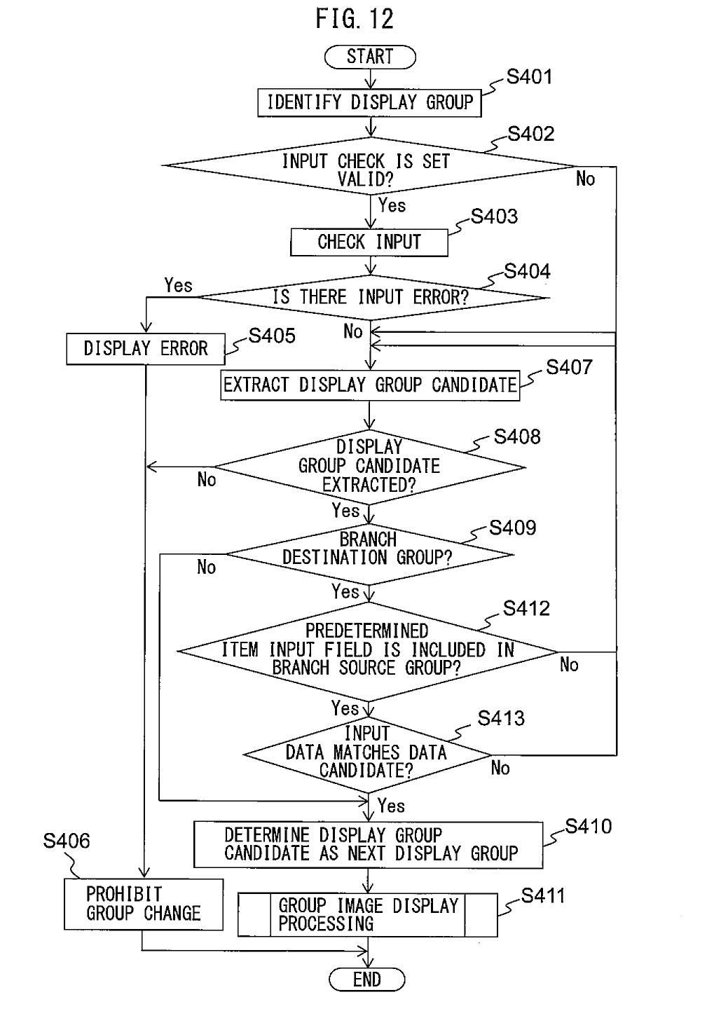

FIG. 12 is a flowchart depicting an example of the operation of the group image change processing.

The operation flow depicted in FIG. 12 is carried out at step S108 of the flowchart depicted in FIG. 6.

The display control module 111 initially identifies the group of which group image is currently displayed on the group image window (step S401).

Next, the input determining module 113 reads out the group display information definition data, and determines whether or not the input check flag of the identified group is set to valid (step S402).

When the input check flag is set to invalid, the input determining module 113 transfers the processing to step S407. Whereas, when the input check flag is set to valid, the input determining module 113 determines whether or not an input to a specific item input field included in the identified group satisfies a predetermined condition before changing the identified group to other group (step S403). The predetermined condition is that data is input in the specific item input field, or a data input in the specific item input field is within a predetermined range or a predetermined character type.

When the input check flag is set to valid, the input determining module 113 reads out the input information definition data, then extracts items of which input is set as required in the required input information among the items included in the group. The input determining module 113 determines whether or not data is input in the item input field of each extracted item, and, when there is an item input field in which data is not input, determines as there is an input error. The input determining module 113 further extracts items, to which is set a range within which input data is supposed to be included or a character type of input data, among the extracted items. The input determining module 113 determines whether or not data input to the item input field of each extracted item is within the set range, and, when the input data is not within the set range, determines as there is an input error. Further, the input determining module 113 determines whether or not data input to the item input field of each extracted item is the set character type, and, when the input data is not the set character type, determines as there is an input error.

When determining there is an input error (step S404: Yes), the input determining module 113 determines that the input to the item input field included in the group does not satisfy a predetermined condition, and displays the effect thereof on the display device 103 (step S405). Next, the input determining module 113 prohibits the group of which group image is currently displayed from changing to another group (step S406). In other words, in this case, the input determining module 113 does not change the group of which group image is currently displayed to another group. Then, the input determining module 113 terminates the series of steps.

Whereas, when the input determining module 113 determines that there is no input error (step S404: No), the display control module 111 reads out the group display information definition data, and extracts a candidate of the group to be displayed next (hereinafter, referred to as the display group candidate) (step S407). When the group image change processing is carried out by pressing the display next button, the display control module 111 extracts the group that is next to the currently displayed group in the display order as the display group candidate. When the display order of the currently displayed group is the last, the display control module 111 does not extract a display group candidate. Whereas, when the group image change processing is carried out by pressing the display previous button, the display control module 111 extracts the group that is previous to the currently displayed group in the display order as the display group candidate. When the display order of the currently displayed group is the first, the display control module 111 does not extract a display group candidate.

Next, the display control module 111 determines whether or not a display group candidate is extracted (step S408).

When no display group candidate is extracted, the display control module 111 prohibits the group of which group image is currently displayed from changing to another group (step S406), and terminates the series of steps.

Whereas, when a display group candidate is extracted, the display control module 111 reads out the group display information definition data, and determines whether or not the extracted display group candidate is set as a branch destination group (step S409).

When the display group candidate is not set as a branch destination group, the display control module 111 determines the display group candidate as the group to be displayed next (step S410). Next, the display control module 111 carries out the group image display processing depicted in FIG. 10, displays the group image relating to the determined group on the display device 103 (step S411), and terminates the series of steps.

Whereas, when the display group candidate is set as a branch destination group, the display control module 111 determines whether or not the display group candidate is associated with a data candidate to be input to a predetermined item input field included in the branch source group (step S412). This branch source group is a branch source group corresponding to the display group candidate that is currently displayed or is previously displayed.

When the display group candidate is not associated with a data candidate to be input to a predetermined item input field, the display control module 111 returns the processing to step S407 and extract a next display group candidate. Whereas, when the display group candidate is associated with a data candidate to be input to a predetermined item input field, the display control module 111 determines whether or not the data input to the predetermined item input field matches the data candidate that is associated with the display group candidate (step S413).

When the data input to the predetermined item input field does not match the data candidate that is associated with the display group candidate, the display control module 111 returns the processing to step S407 and extracts a next display group candidate. Whereas, when the data input to the predetermined item input field matches the data candidate that is associated with the display group candidate, the display control module 111 determines the display group candidate as the group to be displayed next (step S410).

Next, the display control module 111 carries out the group image display processing depicted in FIG. 10, displays the group image relating to the determined group on the display device 103 (step S411), and terminates the series of steps.

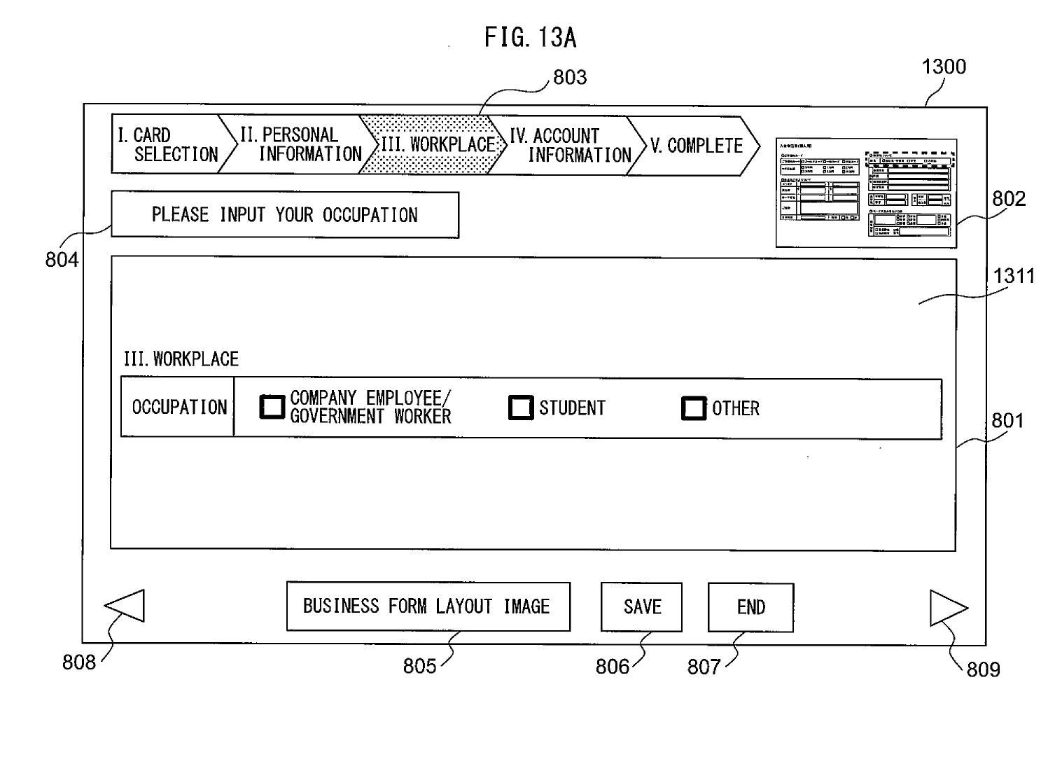

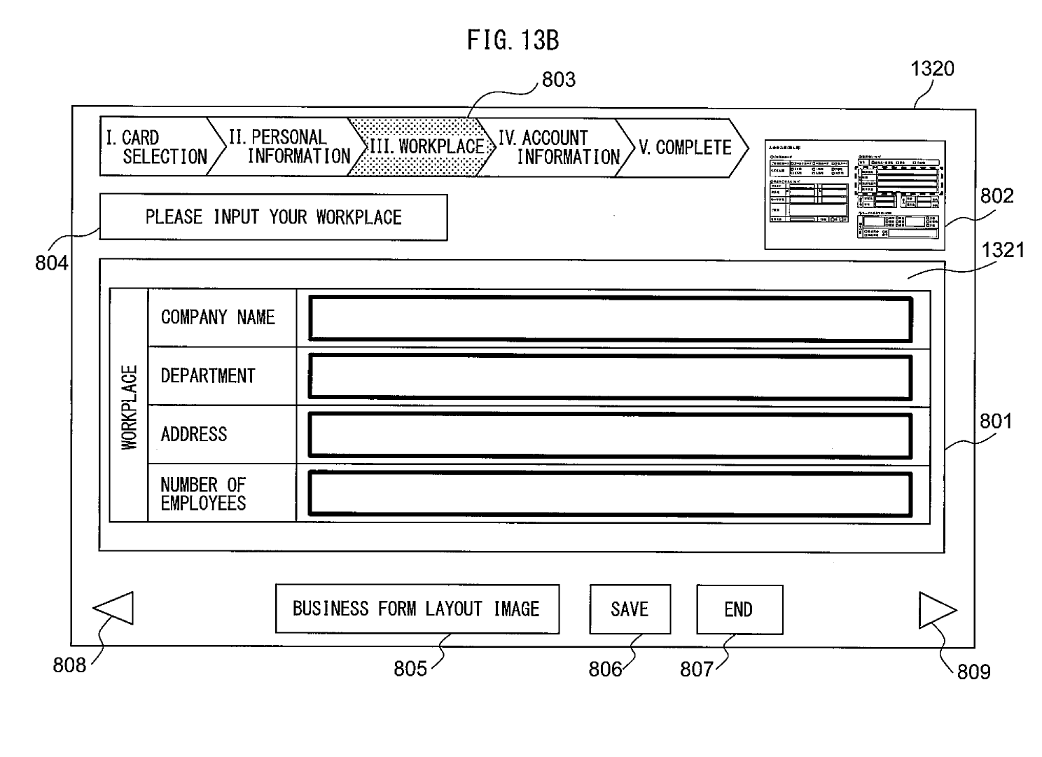

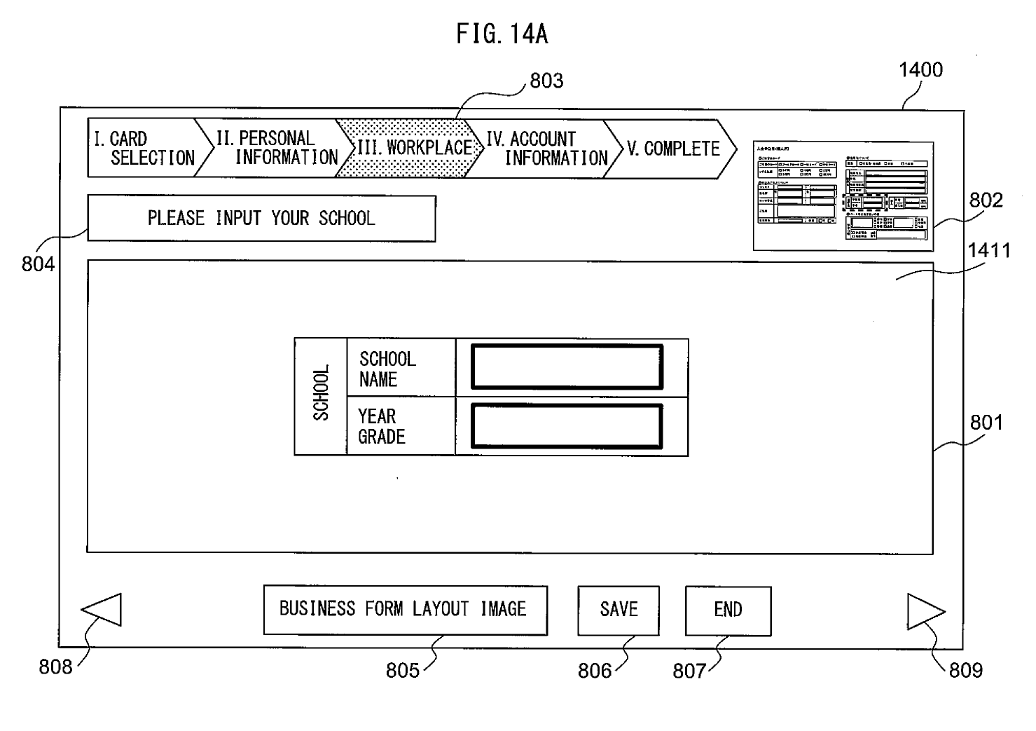

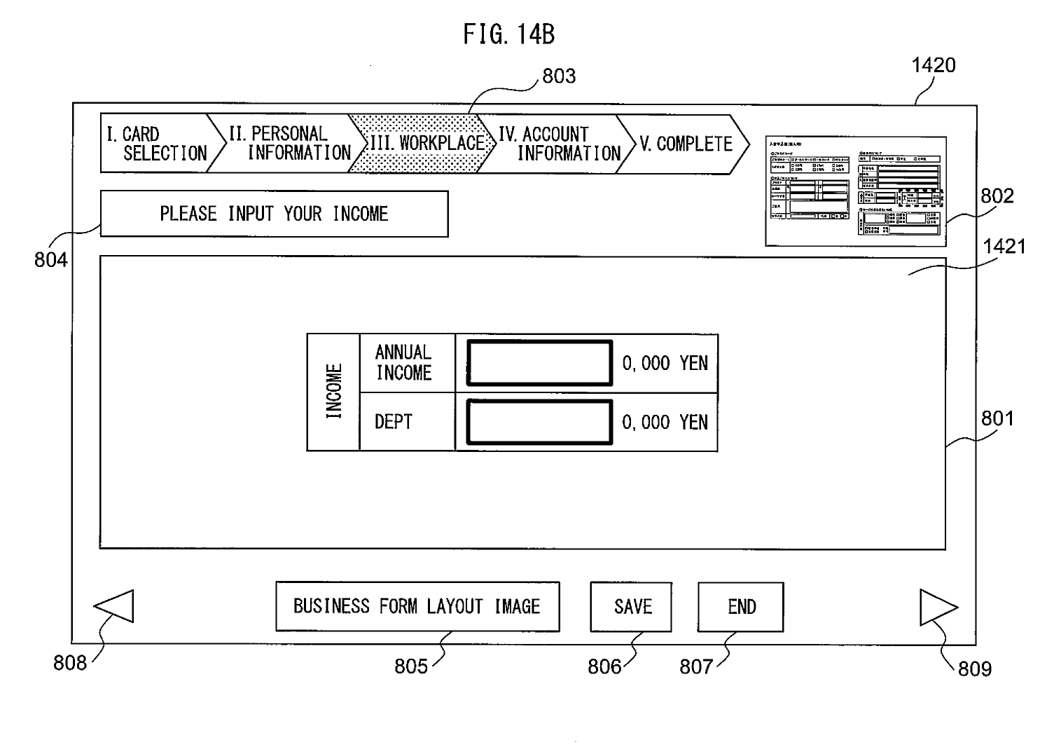

FIGS. 13A, 13B, 14A, and 14B are schematic views for illustrating the branch source group and branch destination groups.

FIG. 13A depicts a group image window 1300 displayed when the display next button 809 is pressed in the group image window 820 depicted in FIG. 8B. The group image 1311 displayed in the group image window 1300 is an image corresponding to the “occupation” group. As depicted in the group display information definition data of FIG. 11, the “occupation” group is a branch source group.

When the “company employee/government worker” is selected (i.e., set as On) in the group image window 1300 of FIG. 13A and the display next button 809 is pressed, the “workplace” group is extracted as a display group candidate based on the group display information definition data of FIG. 11. As depicted in FIG. 11, the “workplace” group is a branch destination group, and the “workplace” group is associated with a data candidate “On” that is input in the item input field “company employee/government worker” included in the “occupation” group. Therefore, the group image window 1320 on which the group image 1321 corresponding to the “workplace” group as depicted in FIG. 13B is displayed.

Subsequently, when the display next button 809 is pressed in the group image window 1320 of FIG. 13B, the “school” group is extracted as a display group candidate based on the group display information definition data of FIG. 11. As depicted in FIG. 11, the “school” group is a branch destination group, and the “school” group is associated with a data candidate “On” that is input to the item input field “student” included in the “occupation” group. Therefore, the group image window 1400 on which is displayed the group image 1411 corresponding to the “student” group as depicted in FIG. 14A is not displayed.

Next, based on the group display information definition data of FIG. 11, the “other” group is extracted as a display group candidate. As depicted in FIG. 11, the “other” group is a branch destination group, and the “other” group is associated with a data candidate “On” that is input in the item input field “company employee/government worker” included in the “occupation” group and a data candidate “On” that is input to the “other”. Therefore, the group image window 1420 on which is displayed the group image 1421 corresponding to the “other” group as depicted in FIG. 14B is displayed next.

By changing the group to be displayed next according to the input data, the information processing device 100 can skip displaying of groups that the worker does not need to input data, which improves the work efficiency of the worker.

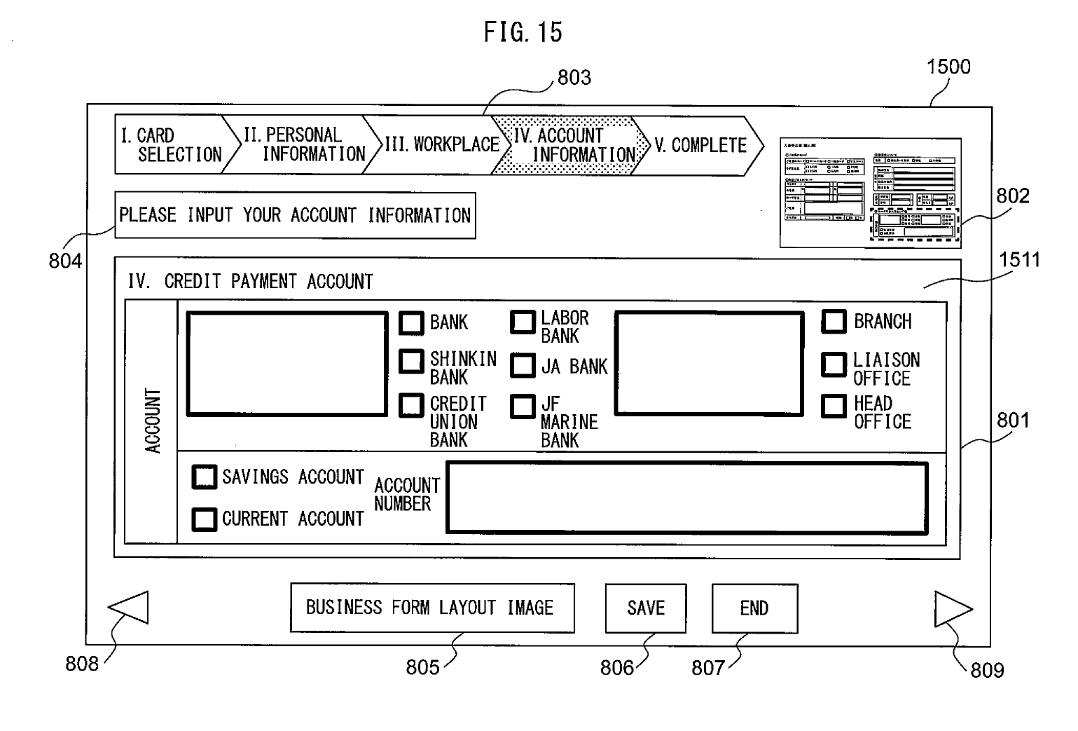

FIG. 15 is a schematic view for illustrating an input check.

FIG. 15 depicts a group image window 1500 displayed when the display next button 809 is pressed on the group image window 1420 depicted in FIG. 14B. The group image 1511 displayed on the group image window 1500 is an image corresponding to the “account information” group. As depicted in FIG. 11, the input check flag of the “account information” group is set as valid. As depicted in FIG. 3A, the required input information of the items “account name” and “account number” in the “account information” group is set as “required”, and the range of the “account number” is set from “1” to “9999999”. Therefore, when data is not input in the “account name” or “account number”, or when the data input to the “account number” is not within the range from “1” to “9999999”, an input error is displayed and the displayed group image does not change.

By carrying out the input check for each group, when there is an omission or error in the input, the information processing device 100 can quickly notify the worker of the effect thereof, which improves the work efficiency of the worker.

As described above in detail, by operating in accordance with the flowcharts depicted in FIGS. 6, 9, 10, and 12, the information processing device 100 categorizes the item input fields in the business form layout image into a plurality of groups, and changes the group image to be displayed according to a user input. Since the item input fields are displayed large in each group image with reference to when displayed in the business form layout image, the user can easily view each piece of information on the image and easily and appropriately select a desired item input field. Therefore, the information processing device 100 can improve user utility when utilizing business forms.

Further, the user can sequentially display necessary item input fields by pressing the display previous button, display next button, and the like without carrying out operation that requires fine tuning, such as zooming, scrolling, and the like, which decreases omissions and errors in the input to the item input fields.

In addition, each group image is a part of the business form layout image and is not necessary to be newly generated, and therefore, increase of development time and development cost can be prevented. Further, each group image is a part of the business form layout image and an arranged position of each item input field is the same as that in the business form layout image, and therefore, a worker can carry out input operation without confusion.

Although the typical embodiments of the present invention have been described, the present invention is not restricted to those embodiments. For example, when data have been input to all the item input fields included in the currently displayed group, the display control module 111 may automatically change the displayed group to another group. In this way, the user can switch the displayed group without pressing the display next button, which can improve user utility.

According to the information processing device, a display method and the computer-readable, non-transitory medium, a plurality of item input fields included in a business form image are categorized into a plurality of groups, and the displayed image of each group is changed in accordance with a user input. As such, the information processing device, the display method, and the computer-readable, non-transitory medium can improve user utility when utilizing a business form with the information processing device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An information processing device comprising:
an operation module for accepting input from a user;
a display;
a storage for storing a business form image representing a business form, and storing a plurality of item input fields each in association with a position at which each item input field is arranged on the business form image, wherein the plurality of item input fields are categorized into a plurality of groups; and
a display control module for displaying a display area including at least an area where all the item input fields included in a specific group among the plurality of groups are arranged in the business form image, changing the specific group to another group among the plurality of groups according to the input from the user accepted by the operation module, and displaying a display area corresponding to the another group on the display.

2. The information processing device according to claim 1, wherein
the storage further stores a display order of the plurality of groups; and
the display control module determines the another group according to the display order.

3. The information processing device according to claim 1, further comprising:
a setting module for setting a display size of the display area, based on a length of at least one direction among horizontal and vertical directions of the display area, and a length of the at least one direction of a window that displays the display area.

4. The information processing device according to claim 1, further comprising:
an input determining module for determining whether or not the input to a specific item input field included in the specific group satisfies a predetermined condition before the display control module changes the specific group to the another group, wherein
when the input to the specific item input field does not satisfy the predetermined condition, the display control module does not change the specific group to the another group.

5. The information processing device according to claim 4, wherein
the predetermined condition is that data is input to the specific item input field, or a data input to the specific item input field is within a predetermined range or is a predetermined character type.

6. The information processing device according to claim 1, wherein
the storage stores a group to be displayed next in association with a data candidate to be input to a predetermined item input field, and
when the specific group includes the predetermined item input field and a data input to the predetermined item input field matches the data candidate stored in the storage, the display control module determines a group associated with the data candidate as the another group.

7. The information processing device according to claim 1, wherein,
when data is input to all the item input fields included in the specific group, the display control module changes the specific group to the another group.

8. The information processing device according to claim 1, wherein
the display control module further displays, on the display, an image representing a whole business form image, as well as, distinguishably representing a display area displayed on the display among the whole business form image.

9. A display method for an information processing device which comprises an operation module accepting input from a user, a display, and a storage, the display method including:
storing a business form image representing a business form in the storage, and storing a plurality of item input fields each in association with a position at which each item input field is arranged on the business form image in the storage, wherein the plurality of item input fields are categorized into a plurality of groups;
displaying a display area including at least an area where all the item input fields included in a specific group among the plurality of groups are arranged in the business form image on the display; and
changing, using a computer, the specific group to another group among the plurality of groups according to the input from the user accepted by the operation module, and displaying a display area corresponding to the another group on the display.

10. A computer-readable, non-transitory medium storing a computer program, wherein the computer program causes a computer which comprises an operation module accepting input from a user, a display, and a storage, to execute a process, the process comprising:
storing a business form image representing a business form in the storage, and storing a plurality of item input fields each in association with a position at which each item input field is arranged on the business form image in the storage, wherein the plurality of item input fields are categorized into a plurality of groups;
displaying a display area including at least an area where all the item input fields included in a specific group among the plurality of groups are arranged in the business form image on the display; and
changing the specific group to another group among the plurality of groups according to the input from the user accepted by the operation module, and displaying a display area corresponding to the another group on the display.
